(19) United States
(12) Patent Application Publication
(10) Pub. No.: US 2019/0367763 A1
(43) Pub. Date: Dec. 5, 2019

(54) SEMI-PROCESSED PRODUCTS FOR EXTEMPORANEOUSLY PRODUCING COVERING FLUID PRODUCTS WHICH ARE OBTAINED BY IDENTIFYING AND RECOMBINING THE COMPONENTS OF A WHITE COVERING FLUID PRODUCT

(71) Applicant: ALFA S.R.L., Bologna (IT)

(72) Inventors: Edoardo ROSSETTI, Calderara di Reno (BO) (IT); Marco ROSSETTI, Calderara di Reno (BO) (IT); Francesco LUNGHINI, Calderara di Reno (BO) (IT); Leopoldo MAZZALVERI, Calderara di Reno (BO) (IT); Chasmine CAIANI, Calderara di Reno (BO) (IT)

(21) Appl. No.: 16/478,374

(22) PCT Filed: Jan. 17, 2018
(86) PCT No.: PCT/IB2018/050292

§ 371 Date: Jul. 16, 2019

(30) Foreign Application Priority Data
Jan. 17, 2017 (IT) 102017000004305

(51) Int. Cl. C09D 17/00; C09D 7/61; C09D 7/43; C09D 7/80; B01F 13/10

(52) U.S. Cl. CPC C09D 17/008; C09D 7/61; B01F 2215/005; C09D 7/80; B01F 13/1061; C09D 7/43

(57) ABSTRACT

A kit of products for extemporaneously preparing covering fluid products, such as varnishes, paints, enamels and other similar decorative products, including a non-pigmented main semi-processed product with one or more binder substances and one or more filler substances which are dispersed in a fluid diluent. The kit also includes at least one pigmented subordinate semi-processed product which contains at least one particulate of titanium dioxide which is dispersed in the fluid diluent. The kit also includes at least one non-pigmented subordinate semi-processed product which contains at least one or more filler substance(s) and one or more binder substance(s) which are dispersed in the fluid diluent.

### FIELD OF THE INVENTION

The present invention relates to the production of covering fluid products at the point of sale. The invention relates to sets of semi-processed products which are capable of being combined in suitable proportions to produce at the point of sale covering fluid products, in particular varnishes, paints, lacquers and other similar decorative products. The invention further relates to methods for combining the semi-processed products so as to produce covering fluid products which are finished and ready for immediate sale to the end user. The invention further relates to means and pieces of equipment which allow the semi-processed products to be processed in order to combine them to produce covering fluid products at the point of sale.

### TECHNOLOGICAL BACKGROUND

There are known various covering fluid products which are used for decorative purposes. The most widespread covering fluid products are varnishes, both transparent and pigmented, also generally referred to as paints.

In the present description, the terms “paint”, “varnish”, “covering fluid product” are used in a substantially mutually equivalent manner and should be understood in relation to the specific context of the present invention. In particular, these terms are intended to refer, with the clarifications which may be inferred from the context, to a material which is formed by different substances dissolved in solvents, with or without addition of diluents, plasticizers, pigments and colourants and, according to circumstances, thickening, fluidizing, wetting agents, etc., which is capable of forming above a surface on which it is suitably spread a thin film having particular properties of hardness, adhesion, brightness, impermeability, flexibility. The covering fluid products to which the present invention relates are used in various sectors for decorating surfaces and comprise, for example, transparent or pigmented varnishes, clear or opaque enamels for wood or metal, water-based paints for internal or external walls, of the washable type, which are breathable, of the “one coat” type (that is to say, which have a covering ability sufficient to cover the surfaces with a single coat of paint), etc. The terms “paint”, “varnish”, “covering fluid product” and the like are also intended to be understood to be covering fluid products which are transparent or pigmented for cosmetic use, such as enamels for nails, hair dyes, etc.

The covering fluid products or varnishes generally comprise the following elements or groups of elements which define the chemical/physical properties thereof:
one or more binder or film-coating substances, also referred to in the field as “emulsions”, which provide the paint with hardness and brilliance of the finished surfaces, such as, for example, synthetic resins, such as polyurethane, acrylic, alkyd, phenolic, styrenic, vinyl and copolymer resins;
filler substances or fillers, such as, for example, calcium carbonate CaCO₃ or barium sulphate BaSO₄, which give body and coverage to the paint; these substances are also known in the sector as “extenders”;
various additives, such as, for example, dispersant, wetting, anti-fermenting compounds.

The above-mentioned elements are dispersed in a diluent medium which is mainly water nowadays.

The varnishes may be transparent or may be pigmented. The pigmented varnishes or paints take on different colourations as a result of various coloured pigments which are dispersed therein. The pigment which is mainly used is titanium dioxide TiO₂ which confers on the paint a white colouration or which is used to lighten other shades, which are produced, for example, by means of an admixture of pigments which provide a yellow, red, blue, black colouration, etc.

Conventionally, the covering fluid products have always been produced in batches in large industrial factories. In the field of paints, these products are known by the name “ready mix”. The industrial productions of “ready mix” allow the production of high volumes with an optimum use of single components of the covering fluid products. In the industrial plants, the single components of the varnishes (resins, fillers, pigments, additives, etc.) are stored in respective great tanks from which they are conveyed in predetermined proportions to the distribution machines which are intended for the production of the transparent or pigmented varnish in accordance with formulations which are well-tested and optimized. The optimization of a varnish or paint involves the most suitable formulation of the various quantities of components in order to obtain a predetermined quality of paint, having repeatable and constant characteristics for each colour both from the point of view of the application (brushability, coverage, viscosity) and from the point of view of the result (resistance, brilliance, resilience, etc.). The optimization achieved in the industrial factories also extends to the use of the minimum quantities of components, types of components which are more expensive, in order to obtain the desired result. Therefore, the industrial production of varnishes, paints, enamels and the like has the advantage of providing a quality of paint which is optimum in relation to the characteristics of the product and the cost thereof. For this reason, the sector of professional decorators is dominated by covering fluid products which are produced in the industrial factories.

However, the production of the so-called “ready mix” covering fluid products in the industrial factories has some significant disadvantages, including the costs of distribution of the products to the points of sale, such as retail outlets or large stores, and the costs of the storage and conservation thereof. These disadvantages are made worse by the fact that it is necessary to produce and store on shelves a variety of paints which are not only different as a result of quality and type of application, but also for each of which it is necessary to provide a rather wide variety of different colourations. These problems make it particularly difficult to produce “ready mix” with a wide range of colourations, resulting in the paints produced in the factory generally being limited in terms of the selection of the colours available to the end users.

In order to solve the problems indicated above in respect of the production of “ready mix” in factories and to mainly meet the requirements of the do-it-yourself market with regard to the selection of a wide range of colours, over time there have become established so-called tintometric systems which allow colouring at the point of sale, by way of suitable colourant dispensing machines, known as mixing machines, a base product of a white colour having a predetermined quality. The white base product is substantially a white finished paint, with a predetermined quantity of titanium dioxide, the characteristics of which involving quality, brilliance, viscosity, etc. are determined in the factory and are not substantially modified when there are added to this white base product modest quantities of concentrated colourants. The tintometric method, which is gradually becoming more widespread both in the paint retail outlets and in the large DIY sales centres, allows a reduction of the warehouse with respect to the storage of “ready mix” products, an increase of the rotation of the stored products and greater compliance with the demands of the customers by providing a range of available colourants which is much broader than the prefabricated ones of the “ready mix” systems. In the tintometric systems there are in fact kept in the warehouse only the base products, where applicable in their different variants of quality of the desired finished product (washable paint, breathable paint, etc.). The tintometric method allows the use of concentrated colourants which are suitably intended for tintometric systems and which are stored in the tanks of the mixing machines, in a state ready for use in order to colour the white base product. The concentrated colourants which are on-board the mixing machine are dispensed in predetermined quantities in accordance with formulations sought by each varnish manufacturer, in the containers filled with the white base product, in such a manner as to obtain a finished paint having the desired colouration.

In the tintometric systems which provide for only the white base product, it is difficult if not impossible to produce very dark tonality of colour, for which it would be necessary to use a substantial quantity of dark colourant for balancing or even neutralizing the white colour of the base product. With a white base, it is further impossible to obtain pure dark colours, such as the colour black. In order to increase the chromatic range which can be produced with the tintometric systems and to reduce the quantity of colourant for producing dark shades, there have been proposed tintometric systems which use, for the same quality of desired finished paint, more than one base product. The simplest multi-base tintometric systems comprise a white base product and a neutral base product, that is to say, it does not contain titanium dioxide. These tintometric systems with two bases allow, for example, the use of the white base product containing titanium dioxide in order to obtain covering fluid products from the pale shades (the so-called pastel colours). The neutral base product which does not contain titanium dioxide is instead used to produce finished covering products having very dark shades.

The tintometric systems with one or two base(s) have the disadvantage of being highly expensive with regard to the optimum use of colourant, in particular in order to obtain intermediate shades between the pastel colours, in which the white base is used, and the very dark tonalities, in which the neutral base is used. Therefore, there have been developed tintometric systems which are more complex and which provide for additional base products with intermediate quantities of titanium dioxide. For example, a system with four bases can provide for a “pure” white base product with a content of titanium dioxide of 25%, a base product for light shades with a content of titanium dioxide of 14%, a base product for medium shades with a content of titanium dioxide of 6%, and a neutral base for dark shades without any titanium dioxide. These more complex systems help to limit the use of colourant in order to approach to the greatest possible extent the ideal formulation proposed by the varnish producer. It is evident that the perfect formulation could be obtained at most at only four levels in a greyscale, that is to say, in a scale of luminosity, which extends from pure white to black. For all the intermediate graduations in the greyscale, it will be in one of the two situations remote from the optimum one: in some cases, it will be necessary to add a quantity of colourant which is greater than the ideal formulation in order to compensate for an excess of titanium dioxide in the base product with respect to the optimum formulation of this shade; in other cases, it will be necessary to add a special white colourant which is concentrated and the cost of which is substantially greater than the cost of the titanium dioxide used in factories for the production of the base product, so as to compensate for the lack of titanium dioxide in the base product with respect to the optimum formulation of this shade.

It is evident that the greater the number of base products which are provided in a tintometric system, the greater is the quantity of different products to be kept in storage and consequently the cost of storage and the complexity of administration of the stock levels. Each quality of paint (breathable, washable paints, clear enamels, matte satin enamels, etc.) then has to have a distinct group of base products therefor because the content and the composition of binders, fillers and additives varies therein. If the number of base products is multiplied by the number of different qualities of paints which it is desirable to provide for customers, it is easy to understand that the costs and the complexity of administration of a tintometric system can be rather high. Another disadvantage of the conventional tintometric systems is the fact that the selection of the base product necessary for obtaining a predetermined finished paint is not straightforward because it is necessary for the preparation operations of the paint at the point of sale to be carried out by specialist operators. It is further necessary to consider that normally there are provided packs of different capacities, for example, half a litre, a litre, etc., for each quality of paint and for each base, which further multiplies the quantity of products for storage.

The conventional tintometric systems solve the problem of storage and the reduced number of shades produced in the factory with the “ready mix” products. However, the conventional tintometric systems introduce other disadvantages and compromises, including the fact that the formulation of each colour is far from the optimum one, resulting in a quality of paint which is generally inadequate for the professional sector and a cost of the colour which is rather high as a result of using, in quantities which are often excessive, concentrated colourants which are more expensive than the coloured pigments used in the factory. Substantially, the tintometric systems are a compromise between the service to the client with regard to the number of shades which can be produced and the quality of the varnishing product. The quality of the base product is worsened by the addition of the concentrated colourants which alter the specific characteristics of the base product proportionally to the quantity thereof. In practice, the loss of quality in the conventional tintometric systems is at a maximum for the dark shades for which, in colorimetric terms, there is the maximum use of colourant. In the tintometric systems which provide a neutral base product, without colouring pigments, the formulation of this neutral base product is different from the white base product precisely in order to take account of the effect which a greater or lesser use of colourant brings about on the quality of the finished paint.

In order to understand the fundamental problems which affect the conventional tintometric systems, it is necessary to note that the finished paints are sold in containers on which the exact quantity of product sold is indicated, generally expressed as a volume. These containers are the same ones which the varnish manufacturer fills with the base product which is stored at the finished product vendor. At the time of the production and sale of a particular finished paint, the specialist operator at the point of sale takes a container of base product, opens it so that the colourants necessary for producing the desired shade are dispensed therein, closes it again, agitates it and conveys it to the client who requested it. Since colourant is added to the containers of base product, the containers are not completely filled with base product, but there is left therein a predetermined volume of space in order to take account of the colourants which will be added. The filling level of a container with respect to the pre-established measurement thereof for sale is called the “fill level”. A fill level of 100% corresponds to the exact volume declared on the container and sold to the end customer. The containers of base product have a fill level less than 100% in order to accommodate the concentrated colourants dispensed at the point of sale. By way of a schematic, exemplary embodiment of a tintometric system with four bases, the fill level of base products which are intended for pastel shades, light shades, medium shades and dark shades (with contents of titanium dioxide of approximately 25%, 14%, 6% and 0%, respectively, as set out above by way of example) could be 100%, 97%, 94% and 90%, respectively, in order to take into account the different quantities of colourant necessary in the optimized formulations for each base product in the respective position on the greyscale.

Just as the content of titanium dioxide for each base product is determined at the outset and is optimized only for a predetermined graduation of luminosity on the greyscale, so the fill level will also be optimized only for the paint predetermined in the greyscale and will be equal, for the same base product, apart from the desired shade of the finished product, which is decided only at the time at the point of sale. All the finished products whose shades, if an optimized formulation were to be followed, would require a quantity of colourant less than the one necessary to achieve a fill level of 100% involve a waste of colourant. The quantities of additional colourant, including the optional special additional white colourant, which are used only for the purpose of reaching, during dispensing at the point of sale, a fill level equal to 100% are wasted colourant quantities. In practice, the greater portion of the shades produced with a conventional tintometric system involve an improper use and a waste of colourant, which is used for a large part only to complete the volume of the container of finished product, simply in order to ensure the quantity of finished paint declared by the vendor.

In order to overcome the disadvantages of the conventional tintometric systems, there have been proposed solutions which provide for industrial machines of small size which are capable of dispensing at the point of sale the same starting products which are used in the large industrial plants of the varnish factories. These machines are complex, require many tanks having different dimensions to contain the various binder, filler and additive products which are capable of ensuring a given autonomy of operation and a sufficient variety of finished products. The administration of these machines and of the raw materials is particularly complex. Furthermore, the binder, filler and additive products per se pose problems of conservation and require particular arrangements for the storage and handling thereof. In fact, machines of this type have not become very widespread.

The document WO 2002/085993 in the name of Bizzio describes a method for producing paints in which there is provided a single base product for each quality of finished product desired. This single base product comprises predetermined quantities of a binder and a filler. The single base product is supplied in pre-filled containers with a quantity less than the quantity of finished product which will be proposed for sale. In WO 2002/085993, for example, there are described a single base product of high quality, the fill level of which (final filling level in the container at the point of sale) is 72% and a single base product of poor quality, with a fill level of 90%. In order to produce a finished paint, there are added to the single base product by means of a dispensing machine suitable quantities of other fluid products which are selected from the group comprising a white colourant which contains titanium dioxide, a filler, and concentrated colourants. The quantities of these other fluid products are calculated so as to complement each other in accordance with the shade of the final paint desired in order to achieve the fill level of 100% in the container of the single base product in relation to the quality of the final product desired. The system described in the document WO 2002/085993 has not yet found any practical use and has some disadvantages which act counter to the introduction thereof. In particular, a system of this type would provide finished paints having a brilliance (gloss) which substantially varies from the light shades or pastel shades to the dark shades. In the case of the dark shades, wherein the quality of the paint is intrinsically a result of the use of a greater quantity of colourants with respect to the light shades, and there is a further worsening of the quality as a result of the use of calcium carbonate CaCO₃ which absorbs the binder to a much greater extent with respect to titanium dioxide which is prevalent in the light shades.

The known systems have disadvantages and limitations which make them expensive, impractical and not very advantageous to use. The object of the present invention is to solve the problems and to overcome the limitations of the prior art.

An object of the invention is therefore to provide a set or kit of products which can be combined together in accordance with suitable formulations for extemporaneously producing a variety of covering fluid products having predetermined characteristics, such as, for example, gloss and/or viscosity and/or PVC (Pigment Volume Concentration), which are substantially constant in a wide range of shades. Another object of the invention is to reduce the logistical costs of the existing systems, both “ready mix” and tintometric systems. Another object of the invention is to produce a system which reduces and optimizes the use of concentrated colourants with respect to the conventional tintometric systems. Another object of the invention is to generally reduce the costs of the covering fluid product produced in an extemporaneous manner, for example, at the point of sale, with respect to the conventional tintometric systems, at the same time maintaining the same level of service for the client by providing an extensive range of shades, much wider than the one which can economically be produced with “ready mix” products which are produced in batches in the factory. Another object of the invention is to provide a flexible, economic and reliable system for multiple uses, including in the professional sector. Another object of the invention is to provide a method for reproducing in an extemporaneous manner, upon request, for example, at the point of sale, a paint having characteristics which are substantially comparable with those of a “ready mix” paint which is produced in batches in an industrial factories.

### Statement of Invention

In order to achieve the objects indicated above, the invention comprises one or more of the characteristics which will be described below. What is intended to form the subject of protection is defined in the appended claims. In particular, there is described below a set or kit of products for extemporaneously preparing covering fluid products, such as varnishes, paints, enamels and other similar decorative products. There is also described a process for formulating such a kit of products from a reference covering fluid product having a predetermined quality and an optimized formulation for the production in batches in a factory (“ready mix”). There is further described a process for extemporaneously preparing covering fluid products, such as varnishes, paints, enamels and other similar decorative products by mixing fluid products which are contained in the kit of products. There is further described a dispensing machine which is suitable for use with the above-mentioned kit of products for extemporaneously preparing covering fluid products, such as varnishes, paints, enamels and other similar decorative products.

According to an aspect, there is described a system for extemporaneously producing covering fluid products. The term “extemporaneously producing” is intended to be understood to mean a production carried out at the time, such as, for example, the production of a single pack of finished paint having a predetermined quality and tonality of colour carried out at the point of sale, after a specific request from an end user. In this sense, the extemporaneous production differs from the production in batches in a factory, where the quantity, quality and tonality of paint produced are determined by sales projections rather than by specific requests from end users. There is described how to extemporaneously produce a finished paint having the quality of the varnish manufacturer.

The system makes provision for a semi-processed single main product for each quality of finished paint desired. Examples of different qualities of finished paint and therefore of corresponding main semi-processed products are a washable finished paint, a finished multi-use paint, an enamel, etc. In addition to the main semi-processed product which is preferably produced in a factory in accordance with optimized formulations, the system described comprises the provision of two or more subordinate semi-processed products and concentrated colourants for finishing the main semi-processed product so as to extemporaneously produce, for example, upon request at the point of sale, a finished covering fluid product, for example, a finished paint, of the desired type. In order to produce the finished covering fluid product, there are provided dispensing machines which are capable of dispensing the subordinate semi-processed products and the concentrated colourants. The dispensing can be carried out in containers or cans which are partially filled beforehand (fill level less than 100%) with the main semi-processed product.

In order to complete the paint at the point of sale, the main semi-processed product is completed with subordinate semi-processed products which are stored in tanks inside a dispensing machine which is suitable for the dispensing thereof. The subordinate semi-processed products have the characteristic of being mutually compatible in order to convert the main semi-processed product into a finished product which is coloured in the desired shade with the addition of concentrated colourants.

According to a preferred aspect, the dispensing machine comprises in particular a plurality of tanks and dispensing circuits for concentrated colourants, and at least four tanks having larger dimensions with relevant dedicated dispensing circuits for at least two pigmented subordinate semi-processed products, respectively, and at least two non-pigmented semi-processed products. Naturally, the number of tanks having larger dimensions may be different from four, and in particular may be three or two in number, if there is used a single pigmented semi-processed product and/or a single non-pigmented semi-processed product.

The semi-processed products, both the main and the subordinate ones, are preferably produced in a factory in order to control the characteristics thereof and to ensure the repeatability and reliability thereof. At the extemporaneous production point, for example, at the point of sale, the subordinate semi-processed products are poured into the tanks of the dispensing machine. The main semi-processed product can also be poured into a dedicated tank having a capacity greater than that of the other tanks of the dispensing machine, or can be provided in single containers and stored on shelves, in a state ready to be used in order to be finished by the dispensing machine of subordinate semi-processed products and colourants.

In the preferred case in which the non-pigmented main semi-processed product is provided in a state packed in single containers, each of them may contain a quantity thereof (fill level) less than a predefined maximum quantity (fill level 100%). The predefined maximum quantity is obtained by adding additional fluid products to the container of the main semi-processed product during the extemporaneous preparation of the covering fluid product, for example, the finished paint of the required colour, at the desired quantity. The fluid products added in an extemporaneous manner to the container of the main semi-processed product are at least one of the two subordinate semi-processed products and one or more concentrated colourants. The fill level which is less than 100% of the main semi-processed product in the containers is calculated beforehand and depends on the quantity of titanium dioxide which is necessary in order to formulate in an optimized manner a finished paint of a white colour, as will be better described below.

Substantially, there is described a set or kit of products for extemporaneously preparing covering fluid products, such as varnishes, paints, enamels and other similar decorative products. This kit comprises a non-pigmented main semi-processed product which comprises one or more binder substances (also called “resins” or “emulsions”) and one or more filler substances (also called “fillers” or “extenders” which are dispersed in a fluid diluent. The kit of products also comprises at least one pigmented subordinate semi-processed product containing at least one particulate of titanium dioxide which is dispersed in the fluid diluent. Furthermore, the kit of products also comprises at least one non-pigmented subordinate semi-processed product containing at least one or more filler substances and one or more binder substances which are dispersed in the fluid diluent.

The kit of products may comprise at least two non-pigmented subordinate semi-processed products which are different from each other as a result of the type and/or quantity of the one or more filler substances and/or the type and/or quantity of the one or more binder substances.

The non-pigmented subordinate semi-processed products therefore comprise an admixture of filler substances, also known as “fillers” or “extenders”, and binders. There can be added thickeners and/or additives. The subordinate semi-proceed products also comprise a diluent—preferably water—in a sufficient quantity to complete the volume. Preferably, the content of filler may vary from approximately 20% to approximately 60% by weight. The one or more binder substances generally constitute a proportion not greater than 50%. Preferably, the total content of binder may vary from 10% to 50% by weight and even more preferably, though in a non-limiting manner, may reach approximately 30% by weight. There can be used as fillers or filler substances products which are known in the sector, such as calcium carbonates, barium sulphates, quartz flour and other products which are compatible and functionally similar substances. The thickening agents and/or additives are selected to ensure for the semi-processed product stability, density, anti-mould characteristics, etc., which are desired and known to a person skilled in the art.

If the kit of products comprises a single non-pigmented subordinate semi-processed product, it preferably comprises one or more filler substances of the type used in the production of high-quality paints. Particularly though non-exclusively, the single non-pigmented subordinate semi-processed product of the kit of products may contain a barium sulphate as a filler substance. In this manner, it is possible to use this single non-pigmented subordinate semi-processed product for producing any type of finished paint, independently of the quality of the main semi-processed product. The greater cost of the non-pigmented subordinate semi-processed product which contains a high-quality filler substance with respect to one containing a filler substance of lesser quality, such as calcium carbonate, is compensated for by a greater simplicity of use, including a lower complexity of administration of the stocks, the supplies and a lower cost of the dispensing machine.

The kit of products may comprise at least two pigmented subordinate semi-processed products which are different from each other as a result of the respective characteristics, for example, brilliance. The pigmented subordinate products may comprise a dispersion of titanium dioxide of various types which may include chlorinated titanium, sulphated titanium, multi-use titanium or the like, which have, for example, different characteristics of brilliance. Each pigmented subordinate semi-processed product may generally contain titanium dioxide at a variable percentage of from approximately 20% to approximately 80% by weight. Each pigmented subordinate semi-processed product may further contain a binder in proportions not greater than approximately 40% by weight. Each pigmented subordinate semi-processed product further contains a diluent—preferably water—at a sufficient quantity. The pigmented subordinate semi-processed product may optionally contain thickening agents and/or additives which are known in the sector.

The kit of products may comprise a group of concentrated colourants. The kit of products may also comprise at least one thickening product or thixotropic product, for example, an acrylic product. In this case, the dispensing machine may comprise a tank and a corresponding dispensing circuit for the thickening product or thixotropic product.

There is further described another aspect which relates to a process for extemporaneously preparing covering fluid products, such as varnishes, paints, enamels and other similar decorative products by mixing fluid products which are contained in a kit of products of the type indicated above. The process comprises the step of providing the non-pigmented main semi-processed product of the kit of products in a container which contains a quantity (fill level) thereof less than a predefined maximum quantity (fill level 100%) of the final covering fluid product. There are also provided a plurality of concentrated colourants. During the extemporaneous preparation of a covering fluid product required, if the non-pigmented main semi-processed product is provided in a closed container, the container of non-pigmented main semi-processed product is first opened. There are then introduced into the container of non-pigmented main semi-processed product selected quantities of the at least one of the subordinate semi-processed products and selected quantities of the at least one of the concentrated colourants, on the basis of formulations produced for obtaining a finished covering fluid product having predetermined characteristics, such as, for example, the brilliance (gloss) and/or the viscosity and/or the PVC (Pigment Volume Concentration), which are substantially constant for any colouration in a range of shades which can generally be obtained.

According to a preferred aspect, there is provision for the introduction into the container of non-pigmented main semi-processed product of selected quantities of at least two pigmented subordinate semi-processed products which are different from each other and/or selected quantities of at least two non-pigmented semi-processed products which are different from each other, on the basis of formulations produced for obtaining a finished covering fluid product having predetermined brilliance (gloss) which is constant for any colouration in a range of shades which can generally be obtained.

According to another aspect, there is provision for the introduction into the container of non-pigmented main semi-processed product of selected quantities of at least one pigmented subordinate semi-processed product and/or selected quantities of at least one non-pigmented semi-processed product which contains a filler substance which is suitable for producing high-quality paints, for example, a barium sulphate, on the basis of formulations produced for obtaining a finished covering fluid product having predetermined characteristics, such as, for example, the brilliance (gloss) and/or the viscosity and/or the PVC (Pigment Volume Concentration), which are substantially constant for any colouration in a range of shades which can generally be obtained.

According to another aspect, it is possible to provide an acrylic thickening or thixotropic fluid product to be introduced into the container of main semi-processed product on the basis of formulations produced for obtaining a finished covering fluid product having a viscosity which is predetermined and constant for any colouration in a range of shades which can generally be obtained. The acrylic thickening or thixotropic product to be added in a machine at the point of sale to the non-pigmented main semi-processed product allows the production of a thixotropic product which cannot be obtained with the conventional tintometric systems. The extemporaneous addition of such a thickening product may partially replace the addition of the semi-processed product comprising fillers and binders.

An advantage of the present invention is that it has an optimized formulation of the components of each finished paint, in accordance with the final shade and the quality of finished product. In particular, it is possible by means of the present invention to identify the most suitable formulation which is capable of producing products having a constant quality for each final shade. A particular feature of the present invention is the possibility of obtaining a constant brilliance or gloss for all the range of shades which can be obtained in respect of the finished product. In fact, conventional tintometric systems have the problem of a gloss which is not constant over the entire range of shades which can be obtained, because the dark colourants provide a different result from the white colourant which contains titanium dioxide. Furthermore, in the conventional systems the greater quantity of colourant necessary to achieve the fill level in the case of dark shades produces a greater dilution of the finished product with respect to the light shades, where the fill level is reached with titanium dioxide. The result is a difference in the viscosity of the paint for the same quality for various shades of the colour card available. Another particular feature of the present invention is the possibility of obtaining a PVC value (Pigment Volume Concentration) which is substantially uniform over the entire range of shades which can be obtained in respect of the finished product. The PVC is an index which gives an idea of the quantity of pigment contained in the finished paint with respect to the quantity of binder. In general terms, maintaining the PVC substantially constant in the range of shades which can be obtained with the present invention means providing for each finished paint a constant level of quality of the paint apart from the shade thereof, because the binder has the important function of binding to each other the pigments of the paint and of providing the desired properties of resilience of the paint and adhesion to the substrate to which it is applied.

The fill level of the main semi-processed product is defined taking account of the quantity of titanium dioxide present in one or more pigmented semi-processed products on-board the machine, after considering the quantity of titanium dioxide necessary for producing a completely white finished paint. Once the fill level is defined, the dispensing machine is controlled to dispense pigmented semi-processed product and/or non-pigmented semi-processed product and concentrated colourants, at proportions suitable for obtaining the desired shade and constant characteristics in terms of brilliance desired, independently of the tonality of colouration desired. In particular, the shades which gradually become darker and darker will be produced with a decreasing quantity of pigmented subordinate semi-processed product, compensated for both by an increasing quantity of non-pigmented subordinate semi-processed product, containing a filler and binder product, and by a concentrated colourant. In particular, the darker colours may have a washability and a brilliance (gloss) which can be compared with those of the lighter colours as a result of the fact that the greater quantity of colourant and the lesser quantity of titanium dioxide which would tend to dilute the final paint are compensated for by the presence of binder in the non-pigmented subordinate semi-processed product.

The preferred use of two non-pigmented subordinate semi-processed products which contain fillers and binders and two pigmented semi-processed products with titanium dioxide having a different brilliance, one of which is clearer and the other more opaque, allows a substantial level of flexibility of finishing of the paint at the point of sale using the main semi-processed product which is produced in a factory and then transported and stored at the place of extemporaneous preparation of the paint, for example, at the point of sale. As a result of the different brilliance of the non-pigmented subordinate semi-processed products and the different absorption of binder which each filler has, there is obtained a flexibility of use according to two governing principles. For example, with the quality of a desired finished paint being fixed, it is possible to formulate the same shade with different opacities, covering a wide range of brilliance (gloss). If, however, a predetermined value of brilliance (gloss) is fixed, it is possible to keep it substantially constant for the entire range of shades, from the pastel shades up to the dark shades.

The system described eliminates the need for using white concentrated colourant which is typical of the conventional tintometric systems which have the substantial disadvantage that the base products which contain too little titanium dioxide have to be lightened with white colourant in order to produce lighter shades than the optimum ones on the basis of the percentage of titanium contained in the base product. Substantially, in the system described here, it is not necessary to provide a white concentrated colourant on-board the machine because the quantity of titanium dioxide which is optimum for producing a predetermined shade is supplied by means of dispensing a suitable quantity of pigmented subordinate semi-processed product which comprises titanium dioxide.

In addition to the advantages discussed above, the system of the present invention allows a reduction of the costs of logistics (transport, storage, marketing) with respect to the tintometric systems which use different base products, and at the same time it provides an important reduction of the cost of the colour with respect to the tintometric systems which use two or three base products.

As mentioned above, there is described a process which allows reproduction at the point of sale of a range of finished paints, the characteristics of which correspond to those of a paint produced in batches in a large industrial plant. It involves a process for formulating a kit of products of the type indicated above, the preliminary step of which is to select a reference white covering fluid product having a predetermined quality and an optimized formulation for production in batches in a factory (“ready mix”). In practice it involves a white paint which a varnish manufacturer produces in a factory and which it considers to be optimum for a predetermined quality. The described process provides for a reference list of the components and the relative proportional quantities thereof in the reference white covering fluid product. This reference list comprises among the other components at least one proportional quantity of titanium dioxide and at least one proportional quantity of fluid diluent, which is normally water. The process then makes provision for the production of a main list, on the basis of the above-mentioned reference list, which is advantageous for the preparation of the main semi-processed product. The main list is obtained by subtracting from the reference list the listed proportional quantity of titanium dioxide and a proportional quantity of diluent which is suitable for optimally diluting the proportional quantity of titanium dioxide. The process thus allows the formulation of a non-pigmented main semi-processed product which is intended to be included in a kit of products for extemporaneously preparing covering fluid products, for example, finished paints. The non-pigmented main semi-processed product has components and relative proportional quantities which are equal to those listed in the main list. It is then possible to formulate at least one pigmented subordinate semi-processed product which is intended to be included in the kit of products and which comprises titanium dioxide which is dispersed in the at least one diluent included in the reference list. It is then possible to formulate at least one non-pigmented subordinate semi-processed product which is intended to be included in the kit of products, containing one or more filler substances and one or more binder substances which are dispersed in the at least one diluent which is included in the reference list.

The one or more filler substances and the one or more binder substances in the at least one non-pigmented subordinate product may be equal to or compatible with the components on the reference list of the components of the reference white covering fluid product.

According to a preferred aspect, there are formulated at least two non-pigmented subordinate semi-processed products which are intended to be included in the kit of products, which are mutually different as a result of the type and/or quantity of the one or more filler substance(s) and/or as a result of the type and/or quantity of the one or more binder substance(s). There may be provision for the use of a single pigmented semi-processed product of the type suitable for producing paints of higher quality, containing, for example, barium sulphate as the filler or “extender”.

According to a preferred aspect, there are formulated at least two pigmented subordinate semi-processed products which are mutually different as a result of the respective characteristics of brilliance.

The process described allows the production of main and subordinate semi-processed products which are different from those used for producing paint in batches in a factory, but which again propose in different combinations and in an equal or equivalent form the fundamental ingredients of the paints (“ready mix”). Therefore, the system provides for the production of a main semi-processed product which contains all the raw materials which ensure a predefined quality. The main semi-processed product is obtained by selecting a reference white paint which has a predetermined quality and which is obtained by means of the combination of fundamental ingredients (binders, fillers, additives, titanium dioxide) according to an optimized formulation which is peculiar to a specific varnish manufacturer. There is removed from the reference white paint the titanium dioxide and the relative quantity of diluent (for example, water) necessary to disperse it. The result is standardized, that is to say, reproportioned with respect to base 100. The main semi-processed product in question can be packed in a container at a predetermined fill level. This semi-processed product has different characteristics with respect to a base product for tintometric systems because, unlike it, it is not a finished product.

The invention will now be described with reference to preferred embodiments which are intended to be considered to be simply examples for the understanding of the person skilled in the art of the principles underpinning the invention and to allow him to carry out at least one example thereof. Naturally, the invention has a wider extent than the specific examples because it can be adapted to the types of more different covering fluid products which have specific formulations and which are very different from each other, and which are typically developed according to the specific knowledge of each varnish manufacturer in accordance with the individual technologies and individual knowledge. In fact, the system proposed by the present invention has a universal character and does not depend for the practical implementation thereof on the specific ingredients which form a specific covering fluid product. Any person skilled in the art, on the basis of his individual specific knowledge and working practices, will therefore be capable of adapting the principles set out in the present patent application to his own processes and products.

### EXAMPLE 1

For producing a kit of semi-processed products, a process is carried out starting, for example, from 100 g of a reference white paint. There is provided a reference list of the components and the relative quantities thereof. The reference list comprises among the other components a quantity of titanium dioxide TiO₂ and a quantity of fluid diluent, in this case water. The reference list obtained is as follows:

| | | |
|---|---|---|
| Water | 25 | g |
| Filler | 10 | g |
| TiO₂ | 20 | g |
| Additives | 4.5 | g |
| Thickening agents | 0.5 | g |
| Binders | 40 | g |

There is obtained from the reference list a main list by subtracting the listed quantity of titanium dioxide and a proportional quantity of water which is adapted to the optimum dispersion thereof. In this case, in order to optimally disperse 20 g of titanium dioxide, there is required 9 g of water. The main list, which is reproportioned with respect to 100 g of product, is as follows:

| | | |
|---|---|---|
| Water | 23 | g |
| Filler | 15.3 | g |
| Additives | 5 | g |
| Thickening agents | 0.7 | g |
| Binders | 56 | g |

There is formulated with the main list a non-pigmented main semi-processed product which has components and relative proportional quantities which are equal to those listed in the main list, less the quantities of titanium dioxide and water which are eliminated from the reference list.

There is also formulated at least one pigmented subordinate semi-processed product which comprises titanium dioxide which is dispersed in water. The titanium dioxide does not necessarily have to be the same as the reference list but may be different. This pigmented subordinate semi-processed product has a white colour which is imparted by the titanium dioxide which in 100 g is present at 70% by weight and is dispersed in 30 g of water.

The combination of the two non-pigmented main and pigmented subordinate semi-processed products at sufficient proportions is capable of reproducing the reference white paint with the same quality.

### EXAMPLE 2

A non-pigmented main semi-processed product which therefore does not contain titanium dioxide has been produced by mixing the following components:

Main semi-processed product

| | Quantity in 1 kg | |
|---|---|---|
| Raw material | (% w/w) | Quantity in 100 cm³ |
| WATER | 229.44 | 26.647 |
| SODIUM | 3.22 | 0.151 |
| HEXAMETAPHOSPHATE | | |
| MECELLOSE | 7.42 | 0.490 |
| REOTAN L | 10.36 | 0.926 |
| COMILEC W14B | 3.64 | 0.406 |
| FLUXAIR C83 | 1.40 | 0.163 |
| CAUSTIC SODA | 1.12 | 0.130 |
| OMYACARB 1AV | 152.60 | 6.564 |
| SEPISOL 224 | 28.00 | 3.423 |
| POLICRIL 547 | 560.00 | 60.784 |
| ACTICIDE ICB5 | 2.80 | 0.316 |
| Total | 1000.00 | 100.00 |

A non-pigmented subordinate semi-processed product which is opaque has been produced by mixing the following components:

Non-pigmented subordinate semi-processed product, opaque

| Raw material | Quantity in 1 kg | Quantity in 100 cm³ |
|---|---|---|
| DEMI WATER | 199.8 | 28.330 |
| PEG200 | 40 | 5.047 |
| THYLOSE HX6000 | 2 | 0.189 |
| BENTONE LT | 2 | 0.164 |
| BENTONE 27 | 2 | 0.158 |
| DYNAWEED 200 | 12 | 1.702 |
| OROTAN N4045 | 15 | 1.636 |
| OMYACARB C120 | 420 | 22.057 |
| TEGO AIREX 902 | 4 | 0.567 |
| POLICRIL 547 | 300 | 39.755 |
| ACTICIDE MBS | 1.8 | 0.248 |
| ACTICIDE F | 1.4 | 0.148 |
| Total | 1000.00 | 100.00 |

A non-pigmented subordinate semi-processed product which is clear has been produced by mixing the following components:

Non-pigmented subordinate semi-processed product, clear

| Raw material | Quantity in 1 kg | Quantity in 100 cm³ |
|---|---|---|
| DEMI WATER | 199.8 | 31.071 |
| PEG200 | 40 | 5.535 |
| THYLOSE HX6000 | 2 | 0.207 |
| BENTONE LT | 2 | 0.180 |
| BENTONE 27 | 2 | 0.173 |
| DYNAWEED 200 | 12 | 1.867 |
| OROTAN N4045 | 15 | 1.794 |
| BARIUM SULPHATE | 420 | 14.514 |
| TEGO AIREX 902 | 4 | 0.622 |
| POLICRIL 547 | 300 | 43.602 |
| ACTICIDE MBS | 1.8 | 0.272 |
| ACTICIDE F | 1.4 | 0.162 |
| Total | 1000.00 | 100.00 |

The commercial names of the above-indicated products are respective manufacturers.

There have further been provided two pigmented subordinate semi-processed products which are titanium slurry in which the titanium dioxide is concentrated to 70% by weight. One of the two titanium slurries contains titanium dioxide which has the commercial name Tioxide TR88 and which is produced by Huntsman. The other titanium slurry contains titanium dioxide which has the commercial name Ti-Pure R-942 and which is produced by DuPont.

Using the above semi-processed products, there have been produced various finished paints using the following colourants:

| | | | Colour |
|---|---|---|---|
| Colourant | Name | Description | index |
| Red | Chromaflo 807-0755 REE | ES Organic Red | PR 254 |
| Blue | Chromaflo 807-7055 EXE | ES Blue | PB 15:3 |
| Yellow | Chromaflo 807-1811 CNE | Yellow Iron Oxide | PY 42 |
| Black | Chromaflo 807-9957 BXE | HS Lamp Black | PBk 7 |

The gloss according to the norm UNI 9389 (ISO 2813-78) of the finished paints was measured using a glossmeter from Elcometer which is capable of measuring the gloss at angles of 20°, 60° and 85°. The results obtained are set out in the following table.

| | Main | | | | | | | |
|---|---|---|---|---|---|---|---|---|
| | semi- | | | | | | | |
| | processed | | | | | | | |
| | product | | | | | | | |
| | fill | Clear | Opaque | Clear | Opaque | | Gloss | Gloss |
| | level | TiO₂ | TiO₂ | filler | filler | Colourant | 60° | 85° |
| COLOUR | (% v/v) | (% v/v) | (% v/v) | (% v/v) | (% v/v) | (% v/v) | (GU) | (GU) |
| WHITE | 84 | 4 | 12 | 0 | 0 | 0 | 11 | 32 |
| RED | 84 | 4.6 | 9.3 | 1.2 | 0.7 | 0.2 | 11.5 | 33 |
| BLUE | 84 | 2 | 5.5 | 3 | 2.5 | 3 | 11 | 31 |
| YELLOW | 84 | 0 | 0 | 0 | 7.7 | 8.3 | 12.5 | 32.5 |
| BLACK | 84 | 0 | 0 | 7 | 4 | 5 | 9 | 32 |

The minimum differences encountered with respect to the gloss are practically indistinguishable with the naked eye.

Naturally, the principle of the invention remaining the same, the forms of embodiment and details of construction may be varied widely with respect to those described and illustrated, without thereby departing from the scope of the present invention.

1. A kit of products for extemporaneously preparing covering fluid products, such as varnishes, paints, enamels and other similar decorative products, comprising:
a non-pigmented main semi-processed product comprising one or more binder substances and one or more filler substances which are dispersed in a fluid diluent;
at least one pigmented subordinate semi-processed product which contains at least one particulate of titanium dioxide which is dispersed in the fluid diluent and
at least one non-pigmented subordinate semi-processed product which contains at least one or more filler substance(s) and one or more binder substance(s) which are dispersed in the fluid diluent.

2. A kit of products according to claim 1, wherein the one or more binder substances in the at least one non-pigmented subordinate semi-processed product constitute on the whole a proportion thereof not greater than 50% by weight.

3. A kit of products according to claim 1, comprising at least two non-pigmented subordinate semi-processed products which are mutually different as a result of the type and/or quantity of the one or more filler substance(s) and/or as a result of the type and/or quantity of the one or more binder substance(s) which are mutually different as a result of the respective characteristics of brilliance.

4. A kit of products according to claim 1, comprising at least two pigmented subordinate semi-processed products which are mutually different as a result of the respective characteristics of brilliance.

5. A kit of products according to claim 1, wherein:
the binder substances are selected from the group comprising synthetic resins, such as polyurethane, acrylic, alkyd, phenolic, styrenic, vinyl and copolymer resins; and
the filler substances are selected from the group comprising calcium carbonate, barium sulphate, barium sulphate and other functionally similar substances.

6. A kit of products according to claim 1, wherein the at least one non-pigmented subordinate semi-processed product contains one or more filler substances which are suitable for the production of paint of a high quality, for example, a barium sulphate.

7. A kit of products according to claim 1, further comprising at least one thickening product or thixotropic product, for example, an acrylic product.

8. A kit of products according to claim 1, further comprising a group of concentrated colourants.

9. A kit of products according to claim 1, wherein the non-pigmented main semi-processed product is provided in a state packed in a container which contains a quantity thereof (fill level) less than a predefined maximum quantity (fill level 100%) of covering fluid product produced by adding at least one of the subordinate semi-processed products to the container, the lesser quantity (fill level<100%) being determined by the quantity of titanium dioxide in the pigmented subordinate semi-processed product which is necessary in order to reproduce a covering fluid product of a white colour.

10. A dispensing machine for use with the kit of products according to claim 1, which is suitable for extemporaneously preparing covering fluid products, such as varnishes, paints, enamels and other similar decorative products, comprising a plurality of tanks and dispensing circuits for concentrated colourants, and at least four tanks having larger dimensions with relevant dedicated dispensing circuits for at least two pigmented subordinate semi-processed products, respectively, and for at least two non-pigmented semi-processed products.

11. A dispensing machine according to claim 10, further comprising at least one tank and a corresponding dispensing circuit for a thickening or thixotropic product.

12. A process for formulating a kit of products according to claim 1, comprising the steps of:
selecting a reference white covering fluid product having a predetermined quality and an optimized formulation for production in batches in a factory (“ready mix”);
providing a reference list of the components and the relative proportional quantities thereof in the reference white covering fluid product, the reference list comprising among the other components at least one proportional quantity of titanium dioxide and at least one proportional quantity of fluid diluent;
obtaining a main list from the reference list by subtracting the listed proportional quantity of titanium dioxide and a proportional quantity of diluent which is suitable for optimally diluting the proportional quantity of titanium dioxide, obtaining a main list;
formulating a non-pigmented main semi-processed product which is intended to be included in the kit of products having components and relative proportional quantities which are equal to those listed in the main list;
formulating at least one pigmented subordinate semi-processed product which is intended to be included in the kit of products, comprising titanium dioxide which is dispersed in the at least one diluent included in the reference list;
formulating at least one non-pigmented subordinate semi-processed product which is intended to be included in the kit of products, containing one or more filler substances and one or more binder substances which are dispersed in the at least one diluent which is included in the reference list.

13. A process according to claim 12, wherein the one or more binder substances in the at least one non-pigmented subordinate semi-processed product generally constitute a proportion thereof not greater than 50% by weight.

14. A process according to claim 12, wherein the one or more filler substance(s) and the one or more binder substance(s) in the at least one non-pigmented subordinate product are equal to or compatible with the components on the reference list of the components of the reference white covering fluid product.

15. A process according to claim 12, wherein there are formulated at least two non-pigmented subordinate semi-processed products which are intended to be included in the kit of products and which are mutually different as a result of the type and/or quantity of the one or more filler substance(s) and/or as a result of the type and/or quantity of the one or more binder substance(s).

16. A process according to claim 12, wherein there are formulated at least two pigmented subordinate semi-processed products which are mutually different as a result of the respective characteristics of brilliance.

17. A process for extemporaneously preparing covering fluid products, such as varnishes, paints, enamels and other similar decorative products, by mixing fluid products which are contained in a kit of products according to claim 1, comprising the following steps:
providing the non-pigmented main semi-processed product of the kit of products in a container which contains a quantity (fill level) thereof less than a predefined maximum quantity (fill level 100%) of the final covering fluid product;
providing a plurality of concentrated colourants;
opening the container of non-pigmented main semi-processed product;
introducing into the container of non-pigmented main semi-processed product selected quantities of the at least one of the subordinate semi-processed products and selected quantities of the at least one of the concentrated colourants, on the basis of formulations produced for obtaining a finished covering fluid product having a predetermined brilliance (gloss) which is constant for any colouration in a range of shades which can generally be obtained.

18. A process according to claim 17, wherein there is provision for introducing into the container of non-pigmented main semi-processed product selected quantities of at least two pigmented subordinate semi-processed products which are mutually different and/or selected quantities of at least two non-pigmented semi-processed products which are mutually different, on the basis of formulations produced for obtaining a finished covering fluid product having a predetermined brilliance (gloss) which is constant for any colouration in a range of shades which can generally be obtained.

19. A process according to claim 17, further comprising the step of providing an acrylic thickening or thixotropic fluid product to be introduced into the container of main semi-processed product on the basis of formulations produced for obtaining a finished covering fluid product having a viscosity which is predetermined and constant for any colouration in a range of shades which can generally be obtained or for producing thixotropic paints.
